(19) United States
(12) Patent Application Publication
(10) Pub. No.: US 2024/0286531 A1
(43) Pub. Date: Aug. 29, 2024

(54) ASSEMBLY FOR VEHICLE SEAT

(71) Applicant: FAURECIA Sièges d'Automobile, NANTERRE (FR)

(72) Inventors: Bertrand TOUZET, POLLHAGEN (FR); Gérald GAROTTE, BELLOU EN HOULME (FR)

(21) Appl. No.: 18/588,702

(22) Filed: Feb. 27, 2024

(30) Foreign Application Priority Data
Feb. 27, 2023 (FR) 2301798

(51) Int. Cl. B60N 2/14; B60N 2/16; B60N 2/90

(52) U.S. Cl. CPC B60N 2/14; B60N 2/90; B60N 2/16

(57) ABSTRACT

The present disclosure relates to a pivoting assembly for a vehicle seat comprising a lower plate comprising at least a first hole; an upper plate pivotally mounted relative to the lower plate about a first axis and comprising at least a second hole; a housing delimited in the direction of the first axis by the upper plate and the lower plate; at least one cable bundle that comprises at least one electrical cable, the cable bundle extending through the at least one first hole of the lower plate and through the at least one second hole of the upper plate, an intermediate portion of the electrical cable being received in the housing, the intermediate portion forming at least one loop about the first axis.

### PRIORITY CLAIM

This application claims priority to French Patent Application FR2301798, filed Feb. 27, 2023, which is expressly incorporated by reference herein.

### BACKGROUND

The present disclosure relates to an assembly for a vehicle seat, in particular with a vertical pivoting function. The present description also relates to a seat comprising such an assembly.

### SUMMARY

According to the present disclosure, a pivoting assembly for a vehicle seat comprises:
A lower plate configured to be connected to a vehicle floor, the lower plate comprising at least a first hole;
an upper plate pivotally mounted relative to the lower plate about a first axis, the upper plate comprising at least a second hole,
a housing delimited in the direction of the first axis by the upper plate and the lower plate;
at least one cable bundle which comprises at least one electrical cable, the cable bundle extending through the at least one first hole of the lower plate and through the at least one second hole of the upper plate, an intermediate portion of the electrical cable being received in the housing, the intermediate portion forming at least one loop around the first axis, the lower plate being configured to support the at least one loop.

Winding the intermediate portion of the cable bundle around the first axis makes it possible to avoid shearing of the cable bundle during the rotation of the upper plate about the first axis relative to the lower plate. Indeed, during the rotation of the upper plate about the first axis relative to the lower plate, the cable bundle can wind or unwind according to the direction of rotation of the upper plate, thus avoiding a shearing effect on the latter, and in particular on each of the electrical cables that it comprises. Premature wear or damage to the cable bundle is thus avoided.

The fact that the intermediate portion of the cable bundle is received in the housing makes it possible to maintain the winding of the cable bundle around the first axis. Thus, in a remarkable manner, the housing receiving the intermediate portion of the cable bundle is obtained by directly connecting the upper plate to the lower plate. In other words, the mounting of the at least one loop of the cable bundle can be directly obtained by assembling only two elements, namely the upper plate and the lower plate. Such a pivoting assembly is therefore advantageously quick and easy to assemble.

The direction of the first axis can coincide with the vertical direction.

The qualifiers of “radial” or “circumferential” orientation are defined in reference to the first axis unless otherwise specified. A radial direction is a direction perpendicular to the direction of the first axis. A circumferential direction, at a point away from the first axis, corresponds to a direction perpendicular to the direction of the first axis and the radial direction. Moreover, unless otherwise specified, the adjectives “interior”, “inner”, “exterior” and “outer” are used with reference to a radial direction so that the interior/inner part, that is radially interior/inner part, of an element is closer to the first axis than the exterior/outer part, that is radially exterior/outer part, of the same element.

The lower plate can be configured to be connected to the vehicle floor directly or via a slideway mechanism adapted to move the seat in a longitudinal direction.

The cable bundle may comprise a sheath wherein the at least one electrical cable is received. The at least one electrical cable can be insulated.

The pivoting of the upper plate about the first axis relative to the lower plate is at least equal to 90°, preferably at least equal to 180°, and even more preferably at least equal to 360°; in certain configurations, it is possible to obtain a multi-turn solution.

The lower plate and/or the upper plate may each be made in a single piece, that is to say monobloc.

The intermediate portion may form between 1 and 3 loops around the first axis. The cable bundle may have a diameter of 10 mm. The cable bundle may have a diameter of less than or equal to 20 mm.

A first end portion of the bundle can be located below the lower plate. The first end portion can open out from the first hole, in particular downward. A second end portion of the cable bundle can be located above the upper plate. The second end portion can open out from the second hole, in particular upward.

The at least one first hole and the at least one second hole may each be arranged at a distance from the first axis.

The first end portion and the second end portion are thus at a distance from the first axis. This makes it possible to avoid twisting of the cable bundle during the rotation of the upper plate about the first axis relative to the lower plate. In other words, off-centering the first end portion and the second end portion from the first axis makes it possible that the bundle does not twist on itself, in particular from the first end portion and the second end portion.

In other words, the first end portion and the second end portion can each be off-centered from the first axis.

The cable bundle can be attached to a lateral edge of the first hole and/or to a lateral edge of the second hole.

It has been observed that this facilitates the winding and the unwinding of the bundle around the first during a significant rotation of the upper plate relative to the lower plate.

One or more cable bundle connectors connected to the cable bundle can be provided. A cable bundle connector may have dimensions less than or equal to 115 m×60 mm×25 mm. The at least one first hole and the at least one second hole can be dimensioned to allow the passage of a cable bundle connector.

The pivoting assembly can comprise at least one articulation mechanism interposed between the lower plate and the upper plate and by means of which the upper plate is mounted pivoting relative to the lower plate about the first axis, the articulation mechanism being arranged between the lower plate and the upper plate in the direction of the first axis at a central area which is centered on the first axis, the at least one loop of the intermediate portion of the cable bundle being wound around the articulation mechanism.

Arranging the articulation mechanism in the central area of the housing makes it possible to obtain a more compact seat. Furthermore, such an arrangement proves to be more robust.

The housing may be annular about the first axis. The articulation mechanism can be located at the center of the housing. The mechanism can radially delimit the inside of the housing.

The articulation mechanism can be configured to block the pivoting of the upper plate about the first axis relative to the lower plate.

The articulation mechanism can be entirely comprised in a cylinder. The cylinder containing the articulation mechanism can be of revolution about the first axis having a diameter of less than 120 mm, preferably a diameter of less than 100 mm, or even less than 80 mm.

The articulation mechanism may be of the continuous or discontinuous type. The articulation mechanism may comprise a first flange and a second flange. The first flange of the articulation mechanism can be secured to the lower plate and the second flange of the articulation mechanism can be secured to the upper plate.

The articulation mechanism may be of the discontinuous type. The articulation mechanism may be of the discontinuous type with toothed locking elements. The articulation mechanism can then be non-motorized. The pivoting assembly can comprise an unlocking control lever intended to be maneuvered by a user of the seat. This forms an inexpensive and reliable solution to propose a seat with a vertical pivoting function. The first flange may comprise a first ring gear and the second flange may comprise guides able to receive and guide locking elements. The locking elements may each have a toothing that is engaged with the first ring gear in a rest state of the articulation mechanism and which is spaced apart from the first ring gear in an unlocked activated state of the articulation mechanism.

The articulation mechanism may be of the continuous hypocyclic type with an eccentric cam. The pivoting assembly may comprise an electric motor connected to the eccentric cam and configured to selectively rotate the eccentric cam. Such a hypocyclic articulation mechanism proves to be cost effective, since they are produced in large quantities for motorized adjustment backrest articulations.

The motor can be positioned below the lower plate. The motor can be positioned below the articulation mechanism. The motor can be secured to the lower plate. In this way, it is possible to have a moderate seat bottom thickness, the motor being in a technical area under the articulation mechanism. An output shaft of the motor can be centered on the first axis.

According to one particular arrangement, the first flange may comprise a first ring gear which comprises first teeth and the second flange may comprise a second ring gear which comprises second teeth. The first ring gear and the second ring gear can permanently engage one another over at least one angular sector under the effect of the control eccentric cam. The first and second ring gears can thus form a hypocyclic interface, whereby the center of the second rotating ring is moved relative to the center of the first ring gear when the control cam rotates.

According to one particular arrangement, a transmission with an Oldham joint principle can be provided to compensate for the eccentric effect generated by the hypocyclic articulation mechanism with eccentric cam, the transmission with an Oldham joint principle being interposed between the articulation mechanism and the upper plate.

Advantageously, the articulation mechanism can be non-reversible, namely a significant torque exerted between the first and second flanges cannot generate a relative movement of the first flange with respect to the second flange, in the absence of rotation of the eccentric cam caused by the rotation of the motor. Thus, when the motor is not controlled, even if a torque is exerted on the seat, there is no pivoting of the seat.

The articulation by the continuous or discontinuous articulation mechanism as described above is the to have a single stage in contrast to a two-stage articulation as described below.

According to the alternative of a two-stage articulation, a first articulation stage and a second articulation stage can be provided respectively comprising a first articulation mechanism and second articulation mechanism 40b), each of which is of the continuous hypocyclic type as described above.

The first articulation mechanism and the second articulation mechanism can be arranged in series. The second flange of the first articulation mechanism can be secured to the first flange of the second articulation mechanism. Thus, the first flange of the first articulation mechanism can be secured to the lower plate and the second flange of the second articulation mechanism can be secured to the upper plate.

The second articulation mechanism can be configured to compensate for the eccentric effect of the first articulation mechanism. In other words, the eccentric effect of the second articulation mechanism is phase-shifted by 180° about the first A1 relative to the eccentric effect of the first articulation mechanism. In this way, the seat can rotate according to a perfectly circular movement without eccentric or hypocyclic parasitic effect.

The pivoting assembly may comprise a centering device for centering the upper plate on the first axis relative to the lower plate.

The upper plate can thus be assembled to the lower plate in a manner centered on the first axis, without it being necessary to implement a centering operation. Such an auto-centered pivoting assembly is faster to implement.

The pivoting assembly may comprise at least one flange rigidly connected to the upper plate, the at least one flange comprising a first wall having a generally cylindrical shape, preferably with a circular arc section, about the first axis. The centering device can be formed by the first wall of the at least one flange.

The first wall of the at least one flange may be radially opposite a radially outer face of the lower plate. The first wall of the at least one flange can act as a guide wall for the pivoting of the upper plate relative to the lower plate.

The pivoting assembly may comprise n flanges, with n an even integer greater than or equal to 2, the flanges being diametrically opposite two by two relative to the first axis, the first wall of each flange having a circular arc section. The circular arc section of each flange can extend angularly over a range between 25° and 35°. The pivoting assembly is thus more compact.

The pivoting assembly may comprise a retention device for retaining the upper plate to the lower plate along the direction of the first axis.

A retention device makes it possible to prevent the lifting of the upper plate in the event of an accident, and therefore to maintain the cohesion of the seat even in the event of a significant impact.

The at least one flange may comprise a first rim protruding from the first wall radially inwardly relative to the first axis, a peripheral portion of the lower plate being inserted in the direction of the first axis between the first rim of the at least one flange and the upper plate to form the retention device.

The at least one flange may comprise a second rim extending from the first wall radially outwards relative to the first axis. The second rim of the at least one flange can be attached to the upper plate, for example by at least one rivet.

The first wall of the at least one flange may extend along the direction of the first axis between a lower end and an upper end. The first rim may protrude from the lower end of the first wall. The second rim may protrude from the upper end of the first wall.

According to a second aspect, which can be considered independently of the first aspect and wherein the cable bundle can be omitted, a vehicle seat assembly is proposed comprising the lower plate configured to be connected to a vehicle floor, the upper plate mounted pivoting relative to the lower plate about a first axis and an annular guiding device comprising a plurality of rolling members interposed between the lower plate and the upper plate and located at a distance from the first axis, and wherein an adjustment system is provided which is adapted to adjust the distance along the direction of the first axis between the lower plate and the upper plate, in particular radially at the rolling members.

The adjustment system makes it possible to avoid play between the rolling members and one and/or the other of the plates, causing noise, or to avoid crushing the rolling members in the direction of the first axis between the upper plate and the lower plate.

The adjustment system may comprise a first tubular wall around the first axis secured directly or indirectly to the lower plate and a second tubular wall around the first axis secured directly or indirectly to the upper plate, one of the first tubular wall and the second tubular wall being at least partially received by shape matching in the other of the first tubular wall and the second tubular wall.

The first tubular wall and the second tubular wall may each be cylindrical of revolution.

The first tubular wall and the second tubular wall can be able to slide relative to one another in the direction of the first axis before they are secured, thus allowing the adjustment of the distance along the direction of the first axis between the lower plate and the upper plate. To this end, the adjustment between the first tubular wall and the second tubular wall can be with play, preferably small. The first tubular wall and the second tubular wall may be able to slide relative to one another in an intermediate configuration of the pivoting assembly.

In an assembled and final configuration of the pivoting assembly, the first tubular wall can be secured to the second tubular wall, in particular by welding.

According to a first embodiment, a single-stage articulation as described with reference to the first aspect can be provided.

In particular, the assembly according to the first embodiment of the second aspect may comprise the articulation mechanism, continuous or discontinuous, as described above relative to the first aspect. The articulation mechanism can be interposed between the lower plate and the upper plate and via which the upper plate is mounted pivoting relative to the lower plate about the first axis, the articulation mechanism being arranged at a central area centered on the first axis. The articulation mechanism may comprise a first flange and a second flange. The first flange of the articulation mechanism can be secured directly or indirectly to the lower plate and the second flange of the articulation mechanism can be secured directly or indirectly to the upper plate.

According to the first embodiment, the adjustment system can be interposed between the articulation mechanism and a first plate among the lower plate and the upper plate. According to a first possibility, the adjustment system can be interposed between the lower plate and the first flange. According to a second possibility, the adjustment system can be interposed between the upper plate and the second flange.

The first tubular wall may be connected to the first plate among the lower plate and the upper plate. “Connected” means that the first tubular wall can be attached by any suitable attachment means or integral with the first plate. The second tubular wall can be connected to the flange of the articulation mechanism that is secured to the first plate. “Connected” means that the second tubular wall can be attached by any suitable attachment means or integral with the corresponding flange.

According to a preferred embodiment of the first embodiment, the adjustment system may comprise an annular member that comprises the second tubular wall. The annular member can be attached to the corresponding flange of the articulation mechanism, in particular by any suitable attachment means, preferably by welding. The annular member may comprise an annular rim extending radially inwards from the second tubular wall. The rim can be connected, preferably by welding, to the corresponding flange of the articulation mechanism. The second tubular wall may surround the articulation mechanism in whole or in part.

The securing of the first tubular wall and the second tubular wall makes it possible to secure the first plate to the corresponding flange of the articulation

According to a second embodiment, a two-stage articulation as described with reference to the first aspect can be provided.

In particular, the assembly according to the second embodiment of the second aspect may comprise a first articulation mechanism and a second articulation mechanism, both continuous, as described above relative to the first aspect. The articulation mechanisms can be arranged in series by being interposed between the lower plate and the upper plate and by means of which the upper plate is mounted pivoting relative to the lower plate about the first axis. The articulation mechanisms can be arranged at a central area centered on the first axis. The articulation mechanisms may each comprise a first flange and a second flange. The first flange of the first articulation mechanism can be secured directly or indirectly to the lower plate and the second flange of the second articulation mechanism can be is secured directly or indirectly to the upper plate.

According to the second embodiment, the adjustment system can be interposed between the lower plate and the first articulation mechanism or between the upper plate and the second articulation mechanism. According to a first possibility, the adjustment system can be interposed between the lower plate and the first flange of the first articulation mechanism. According to a second possibility, the adjustment system can be interposed between the upper plate and the second flange of the second articulation mechanism.

According to a third embodiment, a two-stage articulation as described with reference to the first aspect can be provided.

In particular, the assembly according to the second embodiment of the second aspect may comprise a first articulation mechanism and a second articulation mechanism, both continuous, as described above relative to the first aspect. The articulation mechanisms can be arranged in series by being interposed between the lower plate and the upper plate and by means of which the upper plate is mounted pivoting relative to the lower plate about the first axis. The articulation mechanisms can be arranged at a central area centered on the first axis. The articulation mechanisms may each comprise a first flange and a second flange. The first flange of the first articulation mechanism can be secured directly or indirectly to the lower plate and the second flange of the second articulation mechanism can be is secured directly or indirectly to the upper plate.

According to the third embodiment, the adjustment system can be interposed between the first articulation mechanism and the second articulation mechanism.

The first tubular wall can be connected to the second flange of the first articulation mechanism. “Connected” means that the first tubular wall can be attached by any suitable attachment means or integral with the second flange of the first articulation mechanism. The second tubular wall can be connected to the first flange of the second articulation mechanism. “Connected” means that the second tubular wall can be attached by any suitable attachment means or integral with the first flange of the second articulation mechanism. It will be understood that in this case, the second flange of the first articulation mechanism can be secured to the first flange of the second articulation mechanism via the first tubular wall and the second tubular wall.

According to a preferred embodiment of the third embodiment, the adjustment system can comprise a first annular member that comprises the first tubular wall. The first annular member can be attached to the second flange of the first articulation mechanism, in particular by any suitable attachment means, preferably by welding. The first annular member may comprise a first annular rim extending radially inwards from the first tubular wall. The first rim can be connected, preferably by welding, to the second flange of the first articulation mechanism.

According to a preferred embodiment of the third embodiment, the adjustment system can comprise a second annular member that comprises the second tubular wall. The second annular member can be attached to the first flange of the second articulation mechanism, in particular by any suitable attachment means, preferably by radially inwards from the second tubular wall. The second rim can be connected, preferably by welding, to the first flange of the second articulation mechanism.

The rolling members, farther from the axis than the articulation mechanism, provide a significant lever arm to counter tilting forces exerted on the seat, in particular the application of a horizontal force on the top of the backrest of the seat.

According to one option, the rolling members can be balls. Since balls are a standard supply, a cheap solution is obtained for an annular guide of large diameter, if necessary using a cage to guide the balls. The balls can be kept in an annular cage.

According to another option, the rolling members can be rollers. The rollers are each mounted on an axle attached either to the lower plate, or to the upper plate.

The lower plate and the upper plate can each comprise an annular portion forming a rolling track whereupon the rolling members can roll.

Also proposed is a method for assembling the pivoting assembly according to the second aspect as described above.

The method comprises:
providing a pivoting assembly as described above, wherein the first tubular wall and the second tubular wall are at least partly received by shape matching, one in the first tubular wall and the other in the second tubular wall by being able to slide relative to one another in the direction of the first axis;
moving the lower plate relative to the upper plate along the direction of the first axis by sliding the first tubular wall and the second tubular wall relative to one another to obtain a distance along the direction of the first axis between the lower plate and the upper plate that allows for an adjustment of the rolling members between the lower plate and the upper plate;
securing the first tubular wall to the second tubular wall, preferably by welding.

The adjustment of the rolling members between the lower plate and the upper plate can be without clamping along the direction of the first axis and/or without play along the direction of the first axis. In other words, the rolling members can be inserted between the lower plate and the upper plate can be without clamping along the direction of the first axis and/or without play along the direction of the first axis.

The first aspect and the second aspect of the present disclosure may be combined. The first tubular wall and/or the second tubular wall can delimited, radially inwardly relative to the first axis, the housing of the pivoting assembly. The at least one loop formed by the intermediate portion of the cable bundle can be wound around the first tubular wall and/or the second tubular wall.

A vehicle seat is also proposed comprising a pivoting assembly as described and a seat bottom of a seat that comprises a seat bottom frame, wherein the seat bottom frame is connected to the upper plate, directly or via a raising mechanism.

The seat can comprise one or more control devices to each control a functional device associated with a functionality, for example adjusting the inclination of a backrest of the seat relative to the seat bottom, a massage function, opening and/or closing a window of the vehicle wherein the seat is located, turning a light on and/or off of the vehicle wherein the seat is located, etc.

The at least one electrical cable of the electrical cable harness may be intended for an electrical connection between one of the control devices and the corresponding functional device, or even with an on-board computer of the vehicle. Thus, the at least one electrical cable of the cable bundle may be intended for an electrical connection between at least one of the control or functional devices and a power supply member, such as an electric battery.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 comprises FIGS. 1A and 1B. FIGS. 1A and AB depict a comparative seat with a vertical pivoting function.

FIG. 2 depicts a perspective view of a pivoting assembly of the seat of FIG. 1.

FIG. 3 depicts a perspective view of a first aspect of a pivoting assembly for a seat with a vertical pivoting function according to the present description.

FIG. 4 depicts an exploded perspective view of a pivoting assembly of FIG. 3.

FIG. 5 depicts another exploded perspective view of the pivoting assembly of FIG. 3.

FIG. 6 depicts a perspective cross sectional view of a first embodiment of a second aspect of the pivoting assembly for a seat with a vertical pivoting function according to the present description.

FIG. 7 depicts a perspective cross sectional view of a second embodiment of a second aspect of a pivoting assembly for a seat with a vertical pivoting function according to the present description.

FIG. 8 shows a cross sectional view of a detail of the pivoting assembly according to the first aspect and the second aspect of the present description.

### DETAILED DESCRIPTION

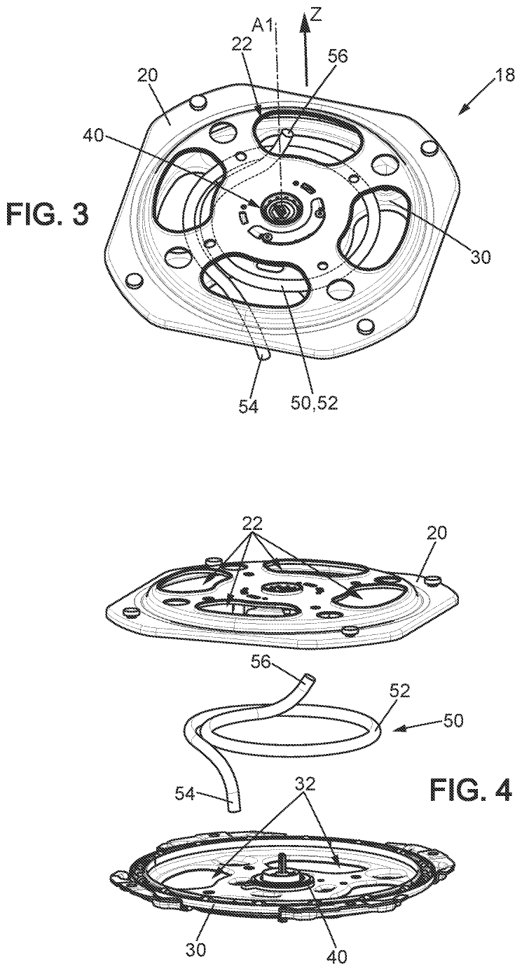

Reference is first made to FIGS. 3 to 5 and 8 to describe a first aspect of a pivoting assembly 18 for a vehicle seat 10 having a vertical pivoting function.

The seat 10 may comprise a seat bottom 12 of the seat 10 that comprises a seat bottom frame 12. The seat 10 can comprise one or more control devices 16 to each control a functional device associated with a functionality, for example adjusting the inclination of a backrest 14 of the seat 10 relative to the seat bottom 12, a massage function, opening and/or closing a window of the vehicle wherein the seat 10 is installed, turning a light on and/or off of the vehicle wherein the seat 10 is installed, etc.

The pivoting assembly 18 comprises a lower plate 30 configured to be connected to a vehicle floor. The lower plate 30 can be configured to be connected to the vehicle floor directly or indirectly via a slideway mechanism adapted to move the seat 10 in a longitudinal direction. The lower plate 30 comprises a plurality of first holes 32, in this case four first holes 32.

The pivoting assembly 18 comprises an upper plate 20 pivotally mounted relative to the lower plate 30 about a first axis A1. The possible pivoting of the upper plate 20 about the first axis A1 relative to the lower plate 30 is at least equal to 90°, preferably at least equal to 180°, and even more preferably at least equal to 360°; in certain configurations, it is possible to obtain a multi-turn solution. The upper plate 20 can be connected to the seat bottom frame 12 of the seat, directly or via a raising mechanism of the seat bottom frame 12. The upper plate 20 comprises a plurality of second holes 22, in this case four second holes 22. The lower plate 30 and the upper plate 20 here are each integral, that is monobloc, which facilitates the assembly of the pivoting assembly 18.

The direction of the first axis A1 here coincides with the vertical direction Z. The qualifiers of “radial” or “circumferential” orientation are defined in reference to the first axis A1 unless otherwise specified. A radial direction is a direction perpendicular to the direction of the first axis A1. A circumferential direction, at a point away from the first axis A1, corresponds to a direction perpendicular to the direction of the first axis A1 and the radial direction. Moreover, unless otherwise specified, the adjectives “interior”, “inner”, “exterior” and “outer” are used with reference to a radial direction so that the interior/inner part, that is to say radially interior/inner part, of an element is closer to the first axis A1 than the exterior/outer part, that is to say radially exterior/outer part, of the same element.

The lower plate 30 and the upper plate 20 define a housing 28. The housing 28 is delimited in the direction of the first axis A1 by the upper plate 20 and the lower plate 30.

The pivoting assembly 18 comprises at least one articulation mechanism 40 interposed between the lower plate 30 and the upper plate 20 and whereby the upper plate 20 is mounted pivoting relative to the lower plate 30 about the first axis A1. The articulation mechanism 40 is also configured here to block the pivoting of the upper plate 20 about the first axis A1 relative to the lower plate 30, when it is in a locked configuration which can be the default configuration of rest. Conversely, in an unlocked configuration of the articulation mechanism 40, the upper plate 20 can pivot about the first axis A1 relative to the lower plate 30 by a manual or motorized action and by means of the articulation mechanism, as is described in more detail below. The articulation mechanism 40 is arranged between the lower plate 30 and the upper plate 20 in the direction of the first axis A1 at a central area which is centered on the first axis A1. Arranging the articulation mechanism 40 in the central area of the housing makes it possible to obtain a more compact seat 10. Furthermore, such an arrangement proves to be more robust. The articulation mechanism 40 is located at the center of the housing 28. In particular, the mechanism radially delimits the inside of the housing 28. The housing 28 is therefore annular here about the first axis A1.

Remarkably, the articulation mechanism 40 can be entirely comprised in a cylinder. The cylinder containing the articulation mechanism 40 can be of revolution about the first axis A1 having a diameter of less than 120 mm, preferably a diameter of less than 100 mm, or even less than 80 mm.

According to the example shown in FIGS. 3 to 5, the articulation by the articulation mechanism 40 is the to be a single-stage articulation in contrast to a two-stage articulation as described below with reference to the second aspect of the pivoting assembly 18 of the present disclosure. However, an embodiment of the pivoting assembly 18 according to the first aspect is not excluded wherein a two-stage articulation is provided.

The articulation mechanism 40 may be of the continuous or discontinuous type. The articulation mechanism 40 may comprise a first flange 41 and a second flange 42. The first flange 41 of the articulation mechanism 40 can be secured to the lower plate 30 and the second flange 42 of the articulation mechanism 40 can be secured to the upper plate 20.

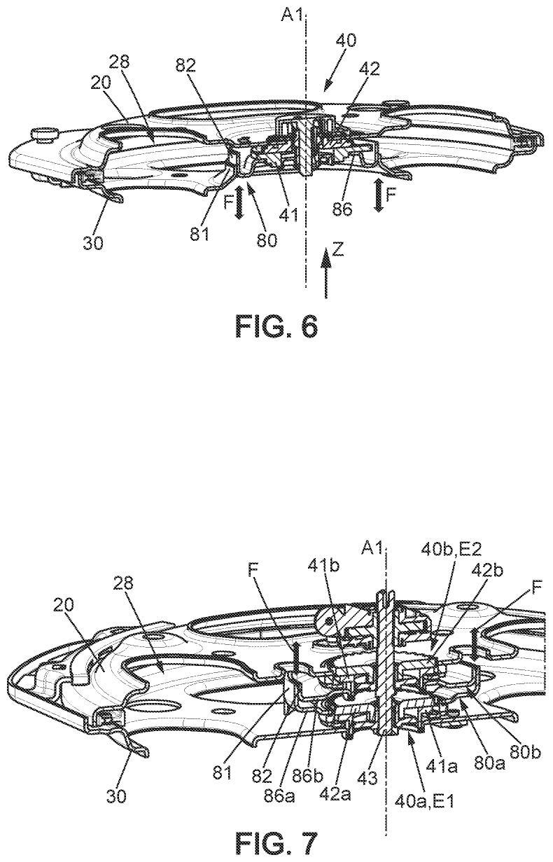

The first flange 41 and the second flange 42 of the articulation mechanism 40 of a single-stage articulation are more particularly visible in FIG. 6 relative to the second aspect of the pivoting assembly 18, which is described in more detail below.

The articulation mechanism 40 may be of the discontinuous type with toothed locking elements. The articulation mechanism 40 can then be non-motorized, that is, with manual action. The pivoting assembly 18 can comprise an unlocking control lever intended to be maneuvered by a user of the seat 10. This forms an inexpensive and reliable solution to propose a seat 10 with a vertical pivoting function. The first flange 41 may comprise a first ring gear and the second flange 42 may comprise guides able to receive and guide locking elements. The locking elements may each have a toothing that is engaged with the first ring gear in a rest state of the articulation mechanism 40 and which is spaced apart from the first ring gear in an unlocked activated state of the articulation mechanism 40.

The articulation mechanism 40 may be of the continuous hypocyclic type with an eccentric cam. The pivoting assembly 18 may comprise an electric motor 70 connected to the eccentric cam and configured to selectively rotate the eccentric cam. Such a hypocyclic articulation mechanism 40 proves to be cost effective, since they are produced in large quantities for motorized adjustment backrest 14 articulations.

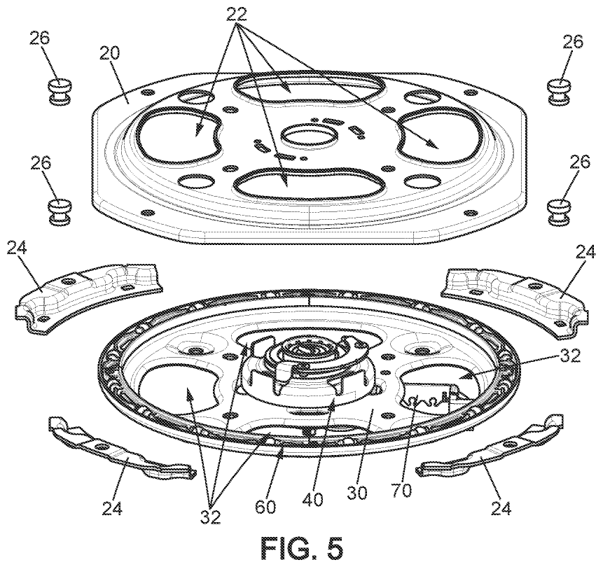

The motor 70, visible in part in FIG. 5, can be positioned below the lower plate 30 and the articulation mechanism 40. The motor 70 can be secured to the lower plate 30. In this way, it is possible to have a moderate seat bottom 12 thickness, the motor 70 being in a technical area under the articulation mechanism 40. An output shaft 43 of the motor 70 can be centered on the first axis A1.

According to one particular arrangement, the first flange 41 may comprise a first ring gear which comprises first teeth and the second flange 42 may comprise a second ring gear which comprises second teeth. The first ring gear and the second ring gear can permanently engage one another over at least one angular sector under the effect of the control eccentric cam. The first and second ring gears can thus form a hypocyclic interface, whereby the center of the second rotating ring is moved relative to the center of the first ring gear when the control cam rotates.

According to one particular arrangement, a transmission with an Oldham joint principle can be provided to compensate for the eccentric effect generated by the hypocyclic articulation mechanism 40 with eccentric cam, the transmission with an Oldham joint principle being interposed between the articulation mechanism 40 and the upper plate 20.

Advantageously, the articulation mechanism 40 can be non-reversible, namely a significant torque exerted between the first and second flanges 41, 42 cannot generate a relative movement of the first flange 41 with respect to the second flange 42, in the absence of rotation of the eccentric cam caused by the rotation of the motor 70. Thus, when the motor 70 is not controlled, even if a torque is exerted on the seat 10, there is no pivoting of the seat 10.

The pivoting assembly 18 further comprises a cable bundle 50 that comprises at least one electrical cable. It is not excluded for the assembly to comprise several cable bundles like the one described below. The cable bundle 50 may comprise a sheath wherein the electrical cable is received. The electrical cable can be insulated. The electrical cable of the cable bundle 50 may be intended for an electrical connection between one of the control devices 16 and the corresponding functional device, or even with an on-board computer of the vehicle wherein the seat is mounted. Thus, the electrical cable of the cable bundle 50 may be intended for an electrical connection between at least one of the control devices 16 or functional devices with a power supply member, such as an electric battery arranged for example under the seat 10 or in the vehicle wherein the seat 10 is mounted.

The cable bundle 50 extends through one of the first holes 32 of the lower plate 30 and through one of the second holes 22 of the upper plate 20, an intermediate portion 52 of the electrical cable then being received in housing 28. A first end portion 54 of the bundle is located below the lower plate 30. The first end portion 54 opens out from the first hole, here downward. A second end portion 56 of the cable bundle 50 is located above the upper plate 20. The second end portion 56 opens out from the second hole, here upward.

Remarkably, the intermediate portion 52 of the cable bundle forms at least one loop around the first axis A1. In this case, the at least one loop of the intermediate portion 52 of the cable bundle 50 is wound about the articulation mechanism 40. The lower plate 30 is configured to support the at least one loop.

Winding the intermediate portion 52 of the cable bundle 50 around the first axis A1 makes it possible to avoid shearing of the cable bundle 50 during the rotation of the upper plate 20 about the first axis A1 relative to the lower plate 30. Indeed, during the rotation of the upper plate 20 about the first axis A1 relative to the lower plate 30, the cable bundle 50 can wind or unwind according to the direction of rotation of the upper plate 20, thus avoiding a shearing effect on the latter, and in particular on each of the electrical cables that it comprises. Premature wear or damage to the cable bundle 50 is thus avoided.

The fact that the intermediate portion 52 of the cable bundle 50 is received in the housing makes it possible to maintain the winding of the cable bundle 50 about the first axis A1. Thus, in a remarkable manner, the housing receiving the intermediate portion 52 of the cable bundle 50 is obtained by directly connecting the upper plate 20 to the lower plate 30. In other words, the mounting of the at least one loop of the cable bundle 50 can be directly obtained by assembling only two elements, namely the upper plate 20 and the lower plate 30. Such a pivoting assembly 18 is therefore advantageously quick and easy to assemble.

Depending on the winding configuration of the cable bundle about the first axis A1, the latter can form between 1 and 5 loops about the first axis A1, preferably between 1 and 3 loops about the first axis A1.

Advantageously, the first hole 32 and the second hole 22 through which the cable bundle extends are arranged at a distance from the first axis A1. The first end portion 54 and the second end portion 56 are thus at a distance from the first axis A1. This makes it possible to avoid twisting of the cable bundle 50 during the rotation of the upper plate 20 about the first axis A1 relative to the lower plate 30. In other words, off-centering the first end portion 54 and the second end portion 56 from the first axis A1 makes it possible that the bundle does not twist on itself, in particular from the first end portion and the second end portion. According to the example shown, each first hole 32 and each second hole 22 is at a distance from the first axis. Thus, it is possible to pass the cable bundle through any one of the first holes 32 and any one of the second holes 22. Thus, the cable bundle 50 can be attached to a lateral edge of the first hole 32 and/or to a lateral edge of the second hole 22 through which it passes. It has been observed that this facilitates the winding and the unwinding of the bundle around the first during a significant rotation of the upper plate 20 relative to the lower plate 30.

The pivoting assembly 18 comprises 4 diametrically opposite flanges 24 in relation to the first axis A1. Each flange 24 is secured to the upper plate 20. Each flange 24 comprises a first wall 24a having a generally cylindrical shape here with a circular arc cross section about the first axis A1. The circular arc section of the first wall of each flange 24 can extend angularly over a range between 25° and 35°. The first wall 24a of each flange 24 is radially opposite a radially outer face of the lower plate 30. The assembly of the first walls 24a of the flanges 24 forms a centering device for centering the upper plate 20 on the first axis A1 relative to the lower plate 30. The upper plate 20 can thus be assembled to the lower plate 30 in a manner centered on the first axis A1, without it being necessary to implement a centering operation. Such an auto-centered pivoting assembly 18 is faster to implement. Thus, the first wall 24a of each flange 24 can act as a guide wall for pivoting the upper plate 20 relative to the lower plate 30.

Each flange comprises a first rim 24b protruding from the first wall 24a radially inwardly relative to the first axis A1. A peripheral portion of the lower plate 30 is inserted in the direction of the first axis A1 between the first rim 24b of each flange 24 and the upper plate 20. A retention device is thus formed for retaining the upper plate 20 to the lower plate 30 along the direction of the first axis A1. A retention device makes it possible to prevent the lifting of the upper plate 20 in the event of an accident, and therefore to maintain the cohesion of the seat 10 even in the event of a significant impact. The first rim 24b protrudes radially inwardly from the lower end of the first wall 24a.

Each flange 24 finally comprises a second rim 24c extending from the first wall 24a radially outwardly relative to the first axis A1. The second rim 24c of each flange 24 is attached to the upper plate 20, in this case by a rivet 26. The second rim 24c protrudes radially outwardly from the upper end of the first wall 24a.

Reference is now made to FIGS. 6 to 8 to describe a second aspect of the pivoting assembly 18 for the vehicle seat 10 having a vertical pivoting function. The second aspect of the pivoting assembly 18 may be considered independently of the first aspect. Thus, the elements relating to the cable bundle, to the centering device and/or to the retention device may be omitted in the pivoting assembly 18 described below.

The pivoting assembly 18 according to the second aspect comprises the lower plate 30 configured to be connected to a vehicle floor, the upper plate 20 mounted pivoting relative to the lower plate 30 about a first axis A1 and an annular guiding device 60 comprising a plurality of rolling members 62 interposed between the lower plate 30 and the upper plate 20 and located at a distance from the first axis A1.

Remarkably with respect to the second aspect of the pivoting assembly 18, the latter comprises an adjustment system adapted to adjust the distance d1 along the direction of the first axis A1 between the lower plate 30 and the upper plate 20, radially at the rolling members 62. The adjustment system makes it possible to avoid play between the rolling members and one and/or the other of the plates 20, 30, causing noise, or to avoid crushing the rolling members in the direction of the first axis A1 between the upper plate 20 and the lower plate 30.

The adjustment system comprises a first tubular wall 81 about the first axis A1 directly or indirectly secured to the lower plate 30 and a second tubular wall 82 about the first axis A1 directly or indirectly secured to the upper plate 20. According to the examples depicted in FIGS. 6 and 7, the second tubular wall 82 is partially received by shape matching in the first tubular wall 81. Thus, in the examples depicted in FIGS. 6 and 7, the first tubular wall and the second tubular wall 82 are each cylindrical of revolution.

The first tubular wall 81 and the second tubular wall 82 are able to slide relative to one another in the direction of the first axis A1 before they are secured, thus allowing the adjustment of the distance d1 along the direction of the first axis A1 between the lower plate 30 and the upper plate 20. To this end, the adjustment between the first tubular wall 81 and the second tubular wall 82 can be with play, preferably small. The first tubular wall 81 and the second tubular wall 82 are able to slide relative to one another in an intermediate assembly configuration of the pivoting assembly assembly 18. In an assembled and final configuration of the pivoting assembly 18, the first tubular wall 81 is secured to the second tubular wall 82, preferably by welding.

FIG. 6 depicts a first embodiment of the second aspect of the pivoting assembly 18. In the first embodiment, a single-stage articulation as described with respect to the first aspect of the pivoting assembly 18 is provided.

In particular, as described above, the assembly according to the first embodiment of the second aspect comprises the continuous or discontinuous articulation mechanism 40. The articulation mechanism 40 is interposed between the lower plate 30 and the upper plate 20 and via which the upper plate 20 is mounted pivoting relative to the lower plate 30 about the first axis A1, the articulation mechanism 40 being arranged at a central area centered on the first axis A1. The articulation mechanism 40 comprises a first flange 41 and a second flange 42. The first flange 41 of the articulation mechanism 40 intended to be secured directly or indirectly to the lower plate 30 and the second flange 42 of the articulation mechanism 40 is intended to be secured directly or indirectly to the upper plate 20.

In the first embodiment, as shown in FIG. 6 according to a first possibility, the adjustment system is interposed between the articulation mechanism 40 and the lower plate 30. More particularly, the adjustment system is interposed between the lower plate 30 and the first flange 41.

The first tubular wall 81 is integral with the lower plate 30. The second tubular wall 82 is connected to the first flange 41. To do this, the adjustment system comprises an annular member 80 that comprises the second tubular wall 82. The annular member 80 is attached to the first flange 41 of the articulation mechanism, preferably by welding. In this respect, the annular member 80 comprises an annular rim 86 extending radially inwardly from the second tubular wall 82. The rim 86 is connected, preferably by welding, to the first flange 41 of the articulation mechanism 40.

The securing of the first tubular wall 81 and the second tubular wall 82 makes it possible to secure the lower plate 30 to the first flange 41 of the articulation mechanism 40.

FIG. 7 depicts a second embodiment of the second aspect of the pivoting assembly 18. In the second embodiment, a two-stage articulation is provided.

In a two-stage articulation, a first articulation stage E1 and a second articulation stage E2 are provided respectively comprising a first articulation mechanism 40a and second articulation mechanism 40b, each of which is of the continuous hypocyclic type as described above in reference to a one-stage articulation.

The first articulation mechanism 40a and the second articulation mechanism 40b are arranged in series by being interposed between the lower plate 30 and the upper plate 20 and by means of which the upper plate 20 is mounted pivoting relative to the lower plate 30 about the first axis A1. The articulation mechanisms 40a, 40b here also are arranged at a central area centered on the first axis A1. The articulation mechanisms 40a, 40b each comprise a first flange 41 and a second flange 42. The second flange 42a of the first articulation mechanism 40a is secured to the first flange 41b of the second articulation mechanism 40b. Thus, the first flange 41a of the first articulation mechanism 40a is secured to the lower plate 30 and the second flange 42b of the second articulation mechanism 42 is secured to the upper plate 20.

The second articulation mechanism 40b can be configured to compensate for the eccentric effect of the first articulation mechanism 40a. In other words, the eccentric effect of the second articulation mechanism 40b is phase-shifted by 180° about the first A1 relative to the eccentric effect of the first articulation mechanism 40a. In this way, the seat 10 can rotate according to a perfectly circular movement without eccentric or hypocyclic parasitic effect. The first articulation mechanism 40a can be coupled to a motor shaft 43 of a motor.

In the second embodiment, the adjustment system is interposed between the first articulation mechanism 40a and the second articulation mechanism 40b.

The first tubular wall 81 is connected to the second flange 42a of the first articulation mechanism 40a. The second tubular wall 82 is connected to the first flange 41b of the second articulation mechanism 40b. It will be understood that, in this case, the second flange 42a of the first articulation mechanism 40a is secured to the first flange 41b of the second articulation mechanism 40b via the first tubular wall 81 and the second tubular wall 82 when the latter are secured to one another. Thus, the first tubular wall 81 is secured to the lower plate 30 in the direction of the first axis A1 via the first articulation mechanism 40a and the second tubular wall 82 is secured to the upper plate 20 in the direction of the first axis A1 via the second articulation mechanism 82.

As can be seen in FIG. 7, the adjustment system comprises a first annular member 80a that comprises the first tubular wall 81. The first annular member 80a is attached to the second flange 42a of the articulation mechanism 40a, preferably by welding. To do this, the first annular member 80a comprises a first annular rim 86a extending radially inwards from the first tubular wall 81. The first rim 86a is connected, preferably by welding, to the second flange 42a of the first articulation mechanism 40a.

The adjustment system here further comprises a second annular member 80b that comprises the second tubular wall 82. The second annular member 80a is attached to the first flange 41b of the second articulation mechanism 40a, preferably by welding. To do this, the second annular member 80b comprises a second annular rim 86b extending radially inwards from the second tubular wall 82. The second rim 86b is connected, preferably by welding, to the first flange 41b of the second articulation mechanism 40b.

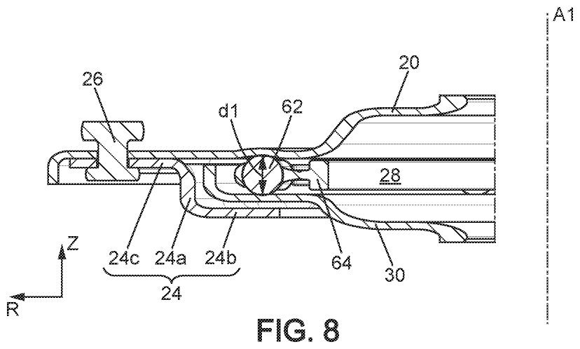

Furthermore, the rolling members 62, farther from the axis than the articulation mechanism 40, provide a significant lever arm to counter tilting forces exerted on the seat 10, in particular the application of a horizontal force on the top of the backrest 14 of the seat 10. According to the example shown in FIG. 8, compatible with the first and second embodiments, the rolling members 62 are here balls. Since balls are a standard supply, a cheap solution is obtained for an annular guide of large diameter, if necessary using a cage to guide the balls. The balls can be kept in an annular cage 64. The lower plate 30 and the upper plate 20 comprise an annular portion forming a rolling track whereupon the rolling members can roll. The distance d1 along the direction of the first axis here separates the rolling track of the lower plate 30 from the rolling track of the upper plate 20. Other types of rolling members can be envisaged.

A method is now described for assembling the pivoting assembly 18 according to the second aspect as described above.

The method comprises a first step. The first step comprises providing a pivoting assembly 18 as described above, wherein the first tubular wall 81 and the second tubular wall 82 are at least partly received by shape matching, one in the first tubular wall 81 and the other in the second tubular wall 82 by being able to slide relative to one another in the direction of the first axis A1. In other words, the first tubular wall and the second tubular wall are not secured to one another, thus making them able to slide relative to one another. This is the intermediate configuration of the pivoting assembly 18.

The method comprises a second step. The second step comprises moving the lower plate 30 relative to the upper plate 20 along the direction of the first axis A1 by sliding the first tubular wall 81 and the second tubular wall 82 relative to one another (depicted by arrows F in FIGS. 6 and 7) to obtain a distance d1 along the direction of the first axis A1 between the lower plate 30 and the upper plate 20 that allows for an adjustment of the rolling members 62 between the lower plate 30 and the upper plate 20.

The adjustment of the rolling members 62 between the lower plate 30 and the upper plate 20 can be without clamping along the direction of the first axis and/or without play along the direction of the first axis. In other words, the rolling members 62 can be inserted between the lower plate 30 and the upper plate 20 can be without clamping along the direction of the first axis and/or without play along the direction of the first axis. In a remarkable manner, the adjustment of the distance d1 between the lower plate 30 and the upper plate 20 is quick and simple.

The method comprises a third step. The third step comprises securing the first tubular wall 81 to the second tubular wall 82, preferably by welding. After the third step, the pivoting assembly is in the assembled and final configuration.

The present disclosure is not limited to the examples described above and is subject to numerous variants.

In particular, the first aspect of the pivoting assembly 18 and the second aspect of the pivoting assembly 18 can be combined in whole or in part.

For example, the first tubular wall 81 and/or the second tubular wall 82 can delimited, radially inwardly relative to the first axis A1, the housing 28 of the pivoting assembly 18. The at least one loop formed by the intermediate portion 52 of the cable bundle 50 can be wound around the first tubular wall 81 and/or the second tubular wall 82.

The cage 64 can radially delimit the outside of the housing 28.

In the following description, when referring to terms qualifying absolute position, such as the terms “front”, “rear”, “top”, “bottom”, “left”, “right”, etc., or relative ones, such as the terms “above”, “below”, “upper”, “lower”, etc., or to qualifiers of orientation, such as “horizontal”, “vertical”, etc., reference is made, unless otherwise specified, to the orientation of the figures or a seat 10 in its normal position of use.

In the following, the longitudinal direction X means the longitudinal direction X of the seat 10. The longitudinal direction X of the seat 10 is considered to be the same as the longitudinal direction X of the motor vehicle wherein the seat 10 is mounted. This longitudinal direction X corresponds to the normal direction FW in which the vehicle advances. The longitudinal direction X is preferably horizontal. The transverse direction Y is the transverse direction Y of the seat 10. The transverse direction Y of the seat 10 thus corresponds to the transverse Y or lateral direction of the motor vehicle. This transverse direction Y corresponds to a direction perpendicular to the normal direction of travel of the vehicle. The transverse direction Y is preferably horizontal. Finally, the vertical direction Z is the direction perpendicular to the direction to the longitudinal direction and the transverse direction Y. The vertical direction Z coincides with the direction of the earth's gravitational field.

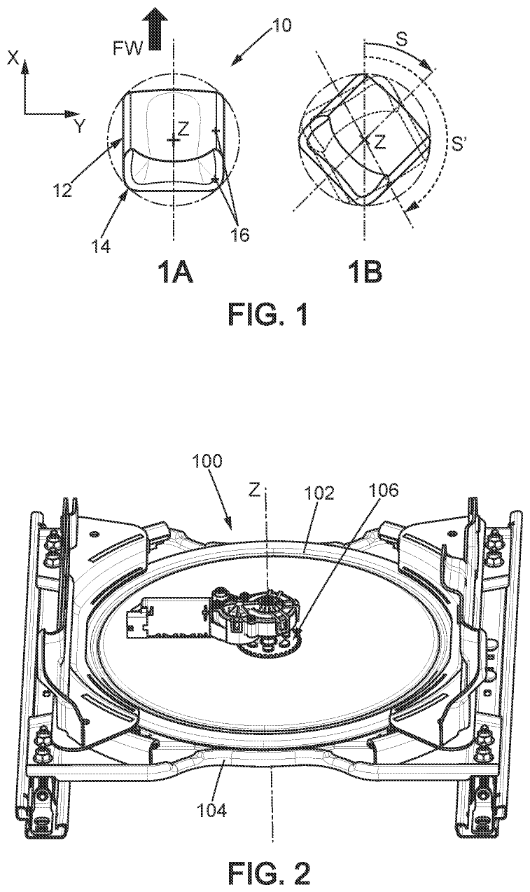

In transport vehicles, the possibility of being able to pivot a passenger's seat 10 to obtain a lounge-type configuration, that is, at least one seat 10 oriented in a position other than forward (represented by arrows S and S′ in FIG. 1b), has already been proposed. The possibility of using a vertical pivot movement to facilitate the entry and exit of (a) passenger(s) in a vehicle when wide door access is not available has also been proposed.

In addition, in the context of more or less advanced driving delegation situations using the autonomous driving functions of the vehicle, not only the passengers but also the driver may prefer a seat 10 position which does not directly face the road, and varied and very different seat 10 orientations may be taken advantage of inside the passenger compartment.

As depicted in FIG. 2, a vehicle seat 10 with a pivoting function with a vertical axis, the pivoting assembly 100 of which comprises a base 104 configured to be connected to the floor of the vehicle directly or via longitudinal slideways, and a rotating ring 102 mounted on the base by means of an articulation mechanism 106, interposed between the base and the rotating ring. The seat 10 further comprises a seat bottom frame 12 of a seat 10 connected to the rotating ring 102.

The seat 10 may comprise one or more control devices 16 to each control a functional device associated with a functionality, for example adjusting the inclination of a backrest 14 of the seat 10 relative to the seat bottom 12, a massage function, opening and/or closing a window of the vehicle wherein the seat 10 is located, turning a light on and/or off of the vehicle wherein the seat 10 is located, etc. The control device(s) 16 can be directly embedded in the seat 10, for example accessible at a seat bottom 12 lining, a backrest lining 14 or an armrest. To this end, it is necessary to provide an electrical connection between each control device 16 and the corresponding functional device, or even with an on-board computer of the vehicle. Furthermore, it is also necessary to provide an electrical connection with an electrical supply member, such as an electric battery, for each functional device and for some, or even all, of the control devices.

These electrical connections are carried out by means of several electrical cables. A bundle of electrical cables thus extends between the floor of the vehicle and the frame of the seat 10. However, in the case of a seat 10 with a vertical pivoting function, the pivoting assembly 100 constitutes an obstacle to the passage of the cable bundle. In addition, the pivoting of the seat 10 causes a shearing and/or torsion of the electrical cables, which may lead to their damage, or even a break.

According to a first aspect, there is proposed a pivoting assembly for a vehicle seat comprising:
A lower plate configured to be connected to a vehicle floor, the lower plate comprising at least a first hole;
an upper plate pivotally mounted relative to the lower plate about a first axis, the upper plate comprising at least a second hole,
a housing delimited in the direction of the first axis by the upper plate and the lower plate;
at least one cable bundle which comprises at least one electrical cable, the cable bundle extending through the at least one first hole of the lower plate and through the at least one second hole of the upper plate, an intermediate portion of the electrical cable being received in the housing, the intermediate portion forming at least one loop around the first axis, the lower plate being configured to support the at least one loop.

Winding the intermediate portion of the cable bundle around the first axis makes it possible to avoid shearing of the cable bundle during the rotation of the upper plate about the first axis relative to the lower plate. Indeed, during the rotation of the upper plate about the first axis relative to the lower plate, the cable bundle can wind or unwind according to the direction of rotation of the upper plate, thus avoiding a shearing effect on the latter, and in particular on each of the electrical cables that it comprises. Premature wear or damage to the cable bundle is thus avoided.

The fact that the intermediate portion of the cable bundle is received in the housing makes it possible to maintain the winding of the cable bundle around the first axis. Thus, in a remarkable manner, the housing receiving the intermediate portion of the cable bundle is obtained by directly connecting the upper plate to the lower plate. In other words, the mounting of the at least one loop of the cable bundle can be directly obtained by assembling only two elements, namely the upper plate and the lower plate. Such a pivoting assembly is therefore advantageously quick and easy to assemble.

The direction of the first axis can coincide with the vertical direction.

The qualifiers of “radial” or “circumferential” orientation are defined in reference to the first axis unless otherwise specified. A radial direction is a direction perpendicular to the direction of the first axis. A circumferential direction, at a point away from the first axis, corresponds to a direction perpendicular to the direction of the first axis and the radial direction. Moreover, unless otherwise specified, the adjectives “interior”, “inner”, “exterior” and “outer” are used with reference to a radial direction so that the interior/inner part, that is radially interior/inner part, of an element is closer to the first axis than the exterior/outer part, that is radially exterior/outer part, of the same element.

The lower plate can be configured to be connected to the vehicle floor directly or via a slideway mechanism adapted to move the seat in a longitudinal direction.

The cable bundle may comprise a sheath wherein the at least one electrical cable is received. The at least one electrical cable can be insulated.

The pivoting of the upper plate about the first axis relative to the lower plate is at least equal to 90°, preferably at least equal to 180°, and even more preferably at least equal to 360°; in certain configurations, it is possible to obtain a multi-turn solution.

The lower plate and/or the upper plate may each be made in a single piece, that is to say monobloc.

The intermediate portion may form between 1 and 3 loops around the first axis. The cable bundle may have a diameter of 10 mm. The cable bundle may have a diameter of less than or equal to 20 mm.

A first end portion of the bundle can be located below the lower plate. The first end portion can open out from the first hole, in particular downward. A second end portion of the cable bundle can be located above the upper plate. The second end portion can open out from the second hole, in particular upward.

The at least one first hole and the at least one second hole may each be arranged at a distance from the first axis.

The first end portion and the second end portion are thus at a distance from the first axis. This makes it possible to avoid twisting of the cable bundle during the rotation of the upper plate about the first axis relative to the lower plate. In other words, off-centering the first end portion and the second end portion from the first axis makes it possible that the bundle does not twist on itself, in particular from the first end portion and the second end portion.

In other words, the first end portion and the second end portion can each be off-centered from the first axis.

The cable bundle can be attached to a lateral edge of the first hole and/or to a lateral edge of the second hole.

It has been observed that this facilitates the winding and the unwinding of the bundle around the first during a significant rotation of the upper plate relative to the lower plate.

One or more cable bundle connectors connected to the cable bundle can be provided. A cable bundle connector may have dimensions less than or equal to 115 mm×60 mm×25 mm. The at least one first hole and the at least one second hole can be dimensioned to allow the passage of a cable bundle connector.

The pivoting assembly can comprise at least one articulation mechanism interposed between the lower plate and the upper plate and by means of which the upper plate is mounted pivoting relative to the lower plate about the first axis, the articulation mechanism being arranged between the lower plate and the upper plate in the direction of the first axis at a central area which is centered on the first axis, the at least one loop of the intermediate portion of the cable bundle being wound around the articulation mechanism.

Arranging the articulation mechanism in the central area of the housing makes it possible to obtain a more compact seat. Furthermore, such an arrangement proves to be more robust.

The housing may be annular about the first axis. The articulation mechanism can be located at the center of the housing. The mechanism can radially delimit the inside of the housing.

The articulation mechanism can be configured to block the pivoting of the upper plate about the first axis relative to the lower plate.

The articulation mechanism can be entirely comprised in a cylinder. The cylinder containing the articulation mechanism can be of revolution about the first axis having a diameter of less than 120 mm, preferably a diameter of less than 100 mm, or even less than 80 mm.

The articulation mechanism may be of the continuous or discontinuous

type. The articulation mechanism may comprise a first flange and a second flange. The first flange of the articulation mechanism can be secured to the lower plate and the second flange of the articulation mechanism can be secured to the upper plate.

The articulation mechanism may be of the discontinuous type. The articulation mechanism may be of the discontinuous type with toothed locking elements. The articulation mechanism can then be non-motorized. The pivoting assembly can comprise an unlocking control lever intended to be maneuvered by a user of the seat. This forms an inexpensive and reliable solution to propose a seat with a vertical pivoting function. The first flange may comprise a first ring gear and the second flange may comprise guides able to receive and guide locking elements. The locking elements may each have a toothing that is engaged with the first ring gear in a rest state of the articulation mechanism and which is spaced apart from the first ring gear in an unlocked activated state of the articulation mechanism.

The articulation mechanism may be of the continuous hypocyclic type with an eccentric cam. The pivoting assembly may comprise an electric motor connected to the eccentric cam and configured to selectively rotate the eccentric cam. Such a hypocyclic articulation mechanism proves to be cost effective, since they are produced in large quantities for motorized adjustment backrest articulations.

The motor can be positioned below the lower plate. The motor can be positioned below the articulation mechanism. The motor can be secured to the lower plate. In this way, it is possible to have a moderate seat bottom thickness, the motor being in a technical area under the articulation mechanism. An output shaft of the motor can be centered on the first axis.

According to one particular arrangement, the first flange may comprise a first ring gear which comprises first teeth and the second flange may comprise a second ring gear which comprises second teeth. The first ring gear and the second ring gear can permanently engage one another over at least one angular sector under the effect of the control eccentric cam. The first and second ring gears can thus form a hypocyclic interface, whereby the center of the second rotating ring is moved relative to the center of the first ring gear when the control cam rotates.

According to one particular arrangement, a transmission with an Oldham joint principle can be provided to compensate for the eccentric effect generated by the hypocyclic articulation mechanism with eccentric cam, the transmission with an Oldham joint principle being interposed between the articulation mechanism and the upper plate.

Advantageously, the articulation mechanism can be non-reversible, namely a significant torque exerted between the first and second flanges cannot generate a relative movement of the first flange with respect to the second flange, in the absence of rotation of the eccentric cam caused by the rotation of the motor. Thus, when the motor is not controlled, even if a torque is exerted on the seat, there is no pivoting of the seat.

The articulation by the continuous or discontinuous articulation mechanism as described above is the to have a single stage in contrast to a two-stage articulation as described below.

According to the alternative of a two-stage articulation, a first articulation stage and a second articulation stage can be provided respectively comprising a first articulation mechanism and second articulation mechanism 40b), each of which is of the continuous hypocyclic type as described above.

The first articulation mechanism and the second articulation mechanism can be arranged in series. The second flange of the first articulation mechanism can be secured to the first flange of the second articulation mechanism. Thus, the first flange of the first articulation mechanism can be secured to the lower plate and the second flange of the second articulation mechanism can be secured to the upper plate.

The second articulation mechanism can be configured to compensate for the eccentric effect of the first articulation mechanism. In other words, the eccentric effect of the second articulation mechanism is phase-shifted by 180° about the first A1 relative to the eccentric effect of the first articulation mechanism. In this way, the seat can rotate according to a perfectly circular movement without eccentric or hypocyclic parasitic effect.

The pivoting assembly may comprise a centering device for centering the upper plate on the first axis relative to the lower plate.

The upper plate can thus be assembled to the lower plate in a manner centered on the first axis, without it being necessary to implement a centering operation. Such an auto-centered pivoting assembly is faster to implement.

The pivoting assembly may comprise at least one flange rigidly connected to the upper plate, the at least one flange comprising a first wall having a generally cylindrical shape, preferably with a circular arc section, about the first axis. The centering device can be formed by the first wall of the at least one flange.

The first wall of the at least one flange may be radially opposite a radially outer face of the lower plate. The first wall of the at least one flange can act as a guide wall for the pivoting of the upper plate relative to the lower plate.

The pivoting assembly may comprise n flanges, with n an even integer greater than or equal to 2, the flanges being diametrically opposite two by two relative to the first axis, the first wall of each flange having a circular arc section. The circular arc section of each flange can extend angularly over a range between 25° and 35°. The pivoting assembly is thus more compact.

The pivoting assembly may comprise a retention device for retaining the upper plate to the lower plate along the direction of the first axis.

A retention device makes it possible to prevent the lifting of the upper plate in the event of an accident, and therefore to maintain the cohesion of the seat even in the event of a significant impact.

The at least one flange may comprise a first rim protruding from the first wall radially inwardly relative to the first axis, a peripheral portion of the lower plate being inserted in the direction of the first axis between the first rim of the at least one flange and the upper plate to form the retention device.

The at least one flange may comprise a second rim extending from the first wall radially outwards relative to the first axis. The second rim of the at least one flange can be attached to the upper plate, for example by at least one rivet.

The first wall of the at least one flange may extend along the direction of the first axis between a lower end and an upper end. The first rim may protrude from the lower end of the first wall. The second rim may protrude from the upper end of the first wall.

According to a second aspect, which can be considered independently of the first aspect and wherein the cable bundle can be omitted, a vehicle seat assembly is proposed comprising the lower plate configured to be connected to a vehicle floor, the upper plate mounted pivoting relative to the lower plate about a first axis and an annular guiding device comprising a plurality of rolling members interposed between the lower plate and the upper plate and located at a distance from the first axis, and wherein an adjustment system is provided which is adapted to adjust the distance along the direction of the first axis between the lower plate and the upper plate, in particular radially at the rolling members.

The adjustment system makes it possible to avoid play between the rolling members and one and/or the other of the plates, causing noise, or to avoid crushing the rolling members in the direction of the first axis between the upper plate and the lower plate.

The adjustment system may comprise a first tubular wall around the first axis secured directly or indirectly to the lower plate and a second tubular wall around the first axis secured directly or indirectly to the upper plate, one of the first tubular wall and the second tubular wall being at least partially received by shape matching in the other of the first tubular wall and the second tubular wall.

The first tubular wall and the second tubular wall may each be cylindrical of revolution.

The first tubular wall and the second tubular wall can be able to slide relative to one another in the direction of the first axis before they are secured, thus allowing the adjustment of the distance along the direction of the first axis between the lower plate and the upper plate. To this end, the adjustment between the first tubular wall and the second tubular wall can be with play, preferably small. The first tubular wall and the second tubular wall may be able to slide relative to one another in an intermediate configuration of the pivoting assembly.

In an assembled and final configuration of the pivoting assembly, the first tubular wall can be secured to the second tubular wall, in particular by welding.

According to a first embodiment, a single-stage articulation as described with reference to the first aspect can be provided.

In particular, the assembly according to the first embodiment of the second aspect may comprise the articulation mechanism, continuous or discontinuous, as described above relative to the first aspect. The articulation mechanism can be interposed between the lower plate and the upper plate and via which the upper plate is mounted pivoting relative to the lower plate about the first axis, the articulation mechanism being arranged at a central area centered on the first axis. The articulation mechanism may comprise a first flange and a second flange. The first flange of the articulation mechanism can be secured directly or indirectly to the lower plate and the second flange of the articulation mechanism can be secured directly or indirectly to the upper plate.

According to the first embodiment, the adjustment system can be interposed between the articulation mechanism and a first plate among the lower plate and the upper plate. According to a first possibility, the adjustment system can be interposed between the lower plate and the first flange. According to a second possibility, the adjustment system can be interposed between the upper plate and the second flange.

The first tubular wall may be connected to the first plate among the lower plate and the upper plate. “Connected” means that the first tubular wall can be attached by any suitable attachment means or integral with the first plate. The second tubular wall can be connected to the flange of the articulation mechanism that is secured to the first plate. “Connected” means that the second tubular wall can be attached by any suitable attachment means or integral with the corresponding flange.

According to a preferred embodiment of the first embodiment, the adjustment system may comprise an annular member that comprises the second tubular wall. The annular member can be attached to the corresponding flange of the articulation mechanism, in particular by any suitable attachment means, preferably by welding. The annular member may comprise an annular rim extending radially inwards from the second tubular wall. The rim can be connected, preferably by welding, to the corresponding flange of the articulation mechanism. The second tubular wall may surround the articulation mechanism in whole or in part.

The securing of the first tubular wall and the second tubular wall makes it possible to secure the first plate to the corresponding flange of the articulation

According to a second embodiment, a two-stage articulation as described with reference to the first aspect can be provided.

In particular, the assembly according to the second embodiment of the second aspect may comprise a first articulation mechanism and a second articulation mechanism, both continuous, as described above relative to the first aspect. The articulation mechanisms can be arranged in series by being interposed between the lower plate and the upper plate and by means of which the upper plate is mounted pivoting relative to the lower plate about the first axis. The articulation mechanisms can be arranged at a central area centered on the first axis. The articulation mechanisms may each comprise a first flange and a second flange. The first flange of the first articulation mechanism can be secured directly or indirectly to the lower plate and the second flange of the second articulation mechanism can be is secured directly or indirectly to the upper plate.

According to the second embodiment, the adjustment system can be interposed between the lower plate and the first articulation mechanism or between the upper plate and the second articulation mechanism. According to a first possibility, the adjustment system can be interposed between the lower plate and the first flange of the first articulation mechanism. According to a second possibility, the adjustment system can be interposed between the upper plate and the second flange of the second articulation mechanism.

According to a third embodiment, a two-stage articulation as described with reference to the first aspect can be provided.

In particular, the assembly according to the second embodiment of the second aspect may comprise a first articulation mechanism and a second articulation mechanism, both continuous, as described above relative to the first aspect. The articulation mechanisms can be arranged in series by being interposed between the lower plate and the upper plate and by means of which the upper plate is mounted pivoting relative to the lower plate about the first axis. The articulation mechanisms can be arranged at a central area centered on the first axis. The articulation mechanisms may each comprise a first flange and a second flange. The first flange of the first articulation mechanism can be secured directly or indirectly to the lower plate and the second flange of the second articulation mechanism can be is secured directly or indirectly to the upper plate.

According to the third embodiment, the adjustment system can be interposed between the first articulation mechanism and the second articulation mechanism.

The first tubular wall can be connected to the second flange of the first articulation mechanism. “Connected” means that the first tubular wall can be attached by any suitable attachment means or integral with the second flange of the first articulation mechanism. The second tubular wall can be connected to the first flange of the second articulation mechanism. “Connected” means that the second tubular wall can be attached by any suitable attachment means or integral with the first flange of the second articulation mechanism. It will be understood that in this case, the second flange of the first articulation mechanism can be secured to the first flange of the second articulation mechanism via the first tubular wall and the second tubular wall.

According to a preferred embodiment of the third embodiment, the adjustment system can comprise a first annular member that comprises the first tubular wall. The first annular member can be attached to the second flange of the first articulation mechanism, in particular by any suitable attachment means, preferably by welding. The first annular member may comprise a first annular rim extending radially inwards from the first tubular wall. The first rim can be connected, preferably by welding, to the second flange of the first articulation mechanism.

According to a preferred embodiment of the third embodiment, the adjustment system can comprise a second annular member that comprises the second tubular wall. The second annular member can be attached to the first flange of the second articulation mechanism, in particular by any suitable attachment means, preferably by radially inwards from the second tubular wall. The second rim can be connected, preferably by welding, to the first flange of the second articulation mechanism.

The rolling members, farther from the axis than the articulation mechanism, provide a significant lever arm to counter tilting forces exerted on the seat, in particular the application of a horizontal force on the top of the backrest of the seat.

According to one option, the rolling members can be balls. Since balls are a standard supply, a cheap solution is obtained for an annular guide of large diameter, if necessary using a cage to guide the balls. The balls can be kept in an annular cage.

According to another option, the rolling members can be rollers. The rollers are each mounted on an axle attached either to the lower plate, or to the upper plate.

The lower plate and the upper plate can each comprise an annular portion forming a rolling track whereupon the rolling members can roll.

Also proposed is a method for assembling the pivoting assembly according to the second aspect as described above.

The method comprises:
providing a pivoting assembly as described above, wherein the first tubular wall and the second tubular wall are at least partly received by shape matching, one in the first tubular wall and the other in the second tubular wall by being able to slide relative to one another in the direction of the first axis;
moving the lower plate relative to the upper plate along the direction of the first axis by sliding the first tubular wall and the second tubular wall relative to one another to obtain a distance along the direction of the first axis between the lower plate and the upper plate that allows for an adjustment of the rolling members between the lower plate and the upper plate;
securing the first tubular wall to the second tubular wall, preferably by welding.

The adjustment of the rolling members between the lower plate and the upper plate can be without clamping along the direction of the first axis and/or without play along the direction of the first axis. In other words, the rolling members can be inserted between the lower plate and the upper plate can be without clamping along the direction of the first axis and/or without play along the direction of the first axis.

The first aspect and the second aspect of the present disclosure may be combined. The first tubular wall and/or the second tubular wall can delimited, radially inwardly relative to the first axis, the housing of the pivoting assembly. The at least one loop formed by the intermediate portion of the cable bundle can be wound around the first tubular wall and/or the second tubular wall.

A vehicle seat is also proposed comprising a pivoting assembly as described and a seat bottom of a seat that comprises a seat bottom frame, wherein the seat bottom frame is connected to the upper plate, directly or via a raising mechanism.

The seat can comprise one or more control devices to each control a functional device associated with a functionality, for example adjusting the inclination of a backrest of the seat relative to the seat bottom, a massage function, opening and/or closing a window of the vehicle wherein the seat is located, turning a light on and/or off of the vehicle wherein the seat is located, etc.

The at least one electrical cable of the electrical cable harness may be intended for an electrical connection between one of the control devices and the corresponding functional device, or even with an on-board computer of the vehicle. Thus, the at least one electrical cable of the cable bundle may be intended for an electrical connection between at least one of the control or functional devices and a power supply member, such as an electric battery.

The present disclosure relates to a pivoting assembly (18) for a vehicle seat (10) comprising a lower plate (30) comprising at least a first hole (32); an upper plate (20) pivotally mounted relative to the lower plate (30) about a first axis (A1) and comprising at least a second hole (22); a housing (28) delimited in the direction of the first axis (A1) by the upper plate (20) and the lower plate (30); at least one cable bundle (50) that comprises at least one electrical cable, the cable bundle (50) extending through the at least one first hole (32) of the lower plate (30) and through the at least one second hole (22) of the upper plate (20), an intermediate portion (52) of the electrical cable being received in the housing, the intermediate portion (52) forming at least one loop about the first axis (A1).

The following numbered clauses include embodiments that are contemplated and non-limiting:

Clause 1. A pivoting assembly (18) for a vehicle seat (10), comprising:
A lower plate (30) configured to be connected to a vehicle floor, the lower plate (30) comprising at least a first hole (32);
an upper plate (20) pivotally mounted relative to the lower plate (30) about a first axis (A1), the upper plate (20) comprising at least a second hole (22),
a housing (28) delimited in the direction of the first axis (A1) by the upper plate (20) and the lower plate (30);
at least one cable bundle (50) which comprises at least one electrical cable, the cable bundle (50) extending through the at least one first hole (32) of the lower plate (30) and through the at least one second hole (22) of the upper plate (20), an intermediate portion (52) of the electrical cable being received in the housing, the intermediate portion (52) forming at least one loop around the first axis (A1), the lower plate (30) being configured to support the at least one loop.

Clause 2. The pivoting assembly (18) according to the preceding clauses, wherein the at least one first hole (32) and the at least one second hole (22) are each arranged at a distance from the first axis (A1).

Clause 3. The pivoting assembly (18) according to clause 1 or 2, wherein the cable bundle (50) is attached to a lateral edge of the first hole (32) and/or to a lateral edge of the second hole (22).

Clause 4. The pivoting assembly (18) according to claim any one of the preceding clauses, comprising at least one articulation mechanism (40) interposed between the lower plate (30) and the upper plate (20) and by means of which the upper plate (20) is mounted pivoting relative to the lower plate (30) about the first axis (A1), the articulation mechanism (40) being arranged between the lower plate (30) and the upper plate (20) in the direction of the first axis (A1) at a central area which is centered on the first axis (A1), the at least one loop of the intermediate portion (52) of the cable bundle (50) being wound around the articulation mechanism (40).

Clause 5. The pivoting assembly (18) according to the preceding clauses, wherein the articulation mechanism (40) is configured to block the pivoting of the upper plate (20) about the first axis (A1) relative to the lower plate (30).

Clause 6. The pivoting assembly (18) according to any one of the preceding clauses, the pivoting assembly (18) comprises a centering device for centering the upper plate (20) on the first axis (A1) relative to the lower plate (30).

Clause 7. The pivoting assembly (18) according to the preceding clause, the pivoting assembly (18) comprising at least one flange (24) rigidly connected to the upper plate (20), the at least one flange (24) comprising a first wall (24a) having a generally cylindrical shape, preferably with a circular arc section, about the first axis (A1), wherein the centering device is formed by the first wall (24a) of the at least one flange (24).

Clause 8. The pivoting assembly (18) according to any one of the preceding clauses, wherein the pivoting assembly (18) comprises a retention device for retaining the upper plate (20) to the lower plate (30) along the direction of the first axis (A1).

Clause 9. The pivoting assembly (18) according to the preceding clause, clause 7 applying, wherein the at least one flange (24) comprises a first rim (24b) protruding from the first wall (24a) radially inwardly relative to the first axis (A1), a peripheral portion of the lower plate (30) being inserted in the direction of the first axis (A1) between the first rim (24b) of the at least one flange (24) and the upper plate (20) to form the retention device.

Clause 10. A vehicle seat (10) comprising a pivoting assembly (18) according to any one of the preceding clauses and a seat bottom (12) of a seat (10) which comprises a seat bottom (12) frame, wherein the seat bottom (12) frame of the seat (10) is connected to the upper plate (20), directly or via a raising mechanism.

1. A pivoting assembly for a vehicle seat, the pivoting assembly comprising:
a lower plate configured to be connected to a vehicle floor, the lower plate comprising at least a first hole;
an upper plate pivotally mounted relative to the lower plate about a first axis, the upper plate comprising at least a second hole,
a housing delimited in the direction of the first axis by the upper plate and the lower plate;
at least one cable bundle which comprises at least one electrical cable, the cable bundle extending through the at least one first hole of the lower plate and through the at least one second hole of the upper plate, an intermediate portion of the electrical cable being received in the housing, the intermediate portion forming at least one loop around the first axis, the lower plate being configured to support the at least one loop.

2. The pivoting assembly of claim 1, wherein the at least one first hole and the at least one second hole are each arranged at a distance from the first axis.

3. The pivoting assembly of claim 1, wherein the cable bundle is attached to a lateral edge of the first hole and/or to a lateral edge of the second hole.

4. The pivoting assembly of claim 1, comprising at least one articulation mechanism interposed between the lower plate and the upper plate and by means of which the upper plate is mounted pivoting relative to the lower plate about the first axis, the articulation mechanism being arranged between the lower plate and the upper plate in the direction of the first axis at a central area which is centered on the first axis, the at least one loop of the intermediate portion of the cable bundle being wound around the articulation mechanism.

5. The pivoting assembly of claim 1, wherein the articulation mechanism is configured to block the pivoting of the upper plate about the first axis relative to the lower plate.

6. The pivoting assembly of claim 1, the pivoting assembly comprises a centering device for centering the upper plate on the first axis relative to the lower plate.

7. The pivoting assembly of claim 1, the pivoting assembly comprising at least one flange rigidly connected to the upper plate, the at least one flange comprising a first wall having a generally cylindrical shape, preferably with a circular arc section, about the first axis, wherein the centering device is formed by the first wall of the at least one flange.

8. The pivoting assembly of claim 1, wherein the pivoting assembly comprises a retention device for retaining the upper plate to the lower plate along the direction of the first axis.

9. The pivoting assembly of claim 7, wherein the pivoting assembly comprises a retention device for retaining the upper plate to the lower plate along the direction of the first axis.

10. The pivoting assembly of claim 9, wherein the at least one flange comprises a first rim protruding from the first wall radially inwardly relative to the first axis, a peripheral portion of the lower plate being inserted in the direction of the first axis between the first rim of the at least one flange and the upper plate to form the retention device.

11. A vehicle seat comprising the pivoting assembly of claim 1 and a seat bottom of a seat which comprises a seat bottom frame, wherein the seat bottom frame of the seat is connected to the upper plate, directly or via a raising mechanism.
